(19) United States
(12) Patent Application Publication
(10) Pub. No.: US 2009/0112351 A1
(43) Pub. Date: Apr. 30, 2009

(54) Product And Method For Manufacturing A Three Dimensional Core Mass And Related Inventions

(76) Inventor: Frederick William Klatt, Bedford, MA (US)

Correspondence Address: Frederick William Klatt, 30 Fox Run Road, Bedford, MA, 01730, US

(21) Appl. No.: 11/924,652

(22) Filed: Oct. 26, 2007

(51) Int. Cl. G06F 19/00

(52) U.S. Cl. 700/118

(57) ABSTRACT

A three dimensional shape core mass is manufactured by machining a ribbon or tape of any material with various slots, channels, or holes of any shape before the ribbon or tape is spooled or layered onto a layering template or spooler. The machining is adjusted so the slots, channels, or holes of any shape extend in a radial or stacked direction perpendicular to the axis of spooling rotation or the plane of layering but with any curve or straight line and with any stacked length. For example, core masses that are manufactured as described are suitable as magnetic cores for high frequency rotating or linear transformers or for rotors and for stators of rotating or linear electric machines when an appropriate magnetic material is used, such as magnetic metal or amorphous metal ribbon or tape.

### PRIOR ART

Manufacturing a three dimensional core mass with channels, slots, or holes of any shape or dimension that extend in a radial direction from the reference center of the core mass is accomplished by a three dimensional machining process of the entire raw core mass, which in essence, cuts minute layers of material from the entire raw core until the desire shape is obtained. This has the advantage of a very fast manufacturing process to final core mass shape but can distort or change the structural, physical, electrical, magnetic, and so-on performance of the bulk material of the raw core mass due to excessive mechanical or heat stress as a result of the fast cutting. In some cases, the final product must be annealed to re-establish acceptable performance of the core material. Further, the machine tool experiences similar stress, which reduces the performance and life of the machine tool.
As used herein, “machining” is a process that modifies raw material by cutting, blasting, stamping, punching, grinding, drilling, slicing/scissoring, or etching with any present or futuristic machine tool.
As used herein, “machine tool” is any present or futuristic machine tooling device, such as lasers, water jets, electrostatic cutter, punches and dies, millers, and so-on.

### OBJECT OF THE INVENTION

One object of the present invention is to provide a machine tool means to manufacture a three dimensional core mass with slots, channels, or holes of any shape or dimension by machining a ribbon or tape of any raw material with the slots, channels, or holes of any shape one layer at a time before the ribbon or tape is spooled (or layered) onto a layering template or spooler. The machining is adjusted so the slots, channels, or holes of any shape extend in a radial or stacked direction perpendicular to the axis of spooling rotation or the plane of layering but following any curve or straight line and with any stacked depth. For example, core masses that are manufactured as described are suitable for axial air-gap magnetic cores for high frequency rotating transformers or for rotor cores and for stator cores of axial-flux rotating electric machines when an appropriate magnetic material, such as magnetic metal or amorphous metal ribbon or tape is used as the raw ribbon material. Furthermore, the core masses that are manufactured as described with the appropriate layering template are suitable for linear transformers and electric machines. This method is different from existing methods because after machining, a portion of the outline of the original raw ribbon shape is obviously distinguishable along the length or circumference of the layering plane. Further, the machining is performed as the ribbon is continuously layered for at least one layer. This method may not be suitable for radial flux machines.

Still another object of the invention is to provide an alternative means to manufacture axial air-gap magnetic cores for rotating electric machines or transformers or for linear electric machines or transformers. This method hydraulically pumps a powdered metal slurry (i.e., with bonding and lubricating agent) into a mold with a negative image of the desired shape of the core while using a wicking method that purges excess bonding agent from the powdered slurry while adding a composite material of strength.

A further object of the invention is to provide a core design for an axial flux air-gap rotating electric machine or transformer. An axial flux air-gap electric machine has a hockey puck or pancake core and is sometimes referred to as a pancake form-factor electric machine.

### BRIEF DESCRIPTION OF THE DRAWINGS

FIG. 1 illustrates the major components of a method of the present invention to manufacture a core mass and the inter-relationship between the various major components, such as the remote machining of each layer of ribbon before it is wound onto the spooler. It should be understood that the spooler could be flattened with the ribbon layered and held on the flattened surface.

FIG. 2 illustrates a partial system of the present invention with one specific means of machining the ribbon with an illustration of a possible ribbon result. For this specific approach, the illustration shows a slot punch machine tool, a continuously running spooler assembly with a LED (or light) template and photo-detector mechanism that activates the slot punch on a particular angle of the spooler, which is based on the slot template, an idler assembly that compensates or modifies ribbon slack between the continuously running spooler and the discretely running punch and die mechanism, the punch and die machine tool that punches a slot in the ribbon cable when activated by the photo-detector, a friction wheel for tightening the ribbon layers on the spooler, and tape guiding bobbins.

FIG. 3 illustrates an alternative method of this invention to manufacturing a core mass of various shapes by molding with a wicking method of removing excess bonding agent from the powdered metal slurry.

### DETAILED DESCRIPTION OF THE INVENTION

In some cases, a better approach for certain final three dimensional core shapes and the subject of this patent is to produce the core mass by wrapping, layering, or spooling thin ribbon or tape onto the layering plane of a layering template or spooler of the ribbon. It should be understood that a round core mass could similarly be laid out flat with the core mass still being build up one layer at a time into a flat or linear core shape. As an example in the case of a flat or linear core shape, the ribbon could be wrapped around a rotating layering template, which is a thin rectangle shape, or layered on one side of a flat layering template with each layer being held in place for the layering effect.
As used herein, “ribbon” is synonymous with tape and the width and thickness of the ribbon can be any size.
As used herein, “spooling” is synonymous with wrapping, winding, layering, or stacking.
As used herein, “spooled” is synonymous with wound, wrapped, stacked, or layered.
As used herein, “spooler” is synonymous with a layering template that is wound upon, stacked upon, wrapped upon, or layered upon.
As used herein, “radial” direction is synonymous with stacking direction or layering direction.
As used herein, “perimeter” is the length of a layered plane that is measured along the direction of layering and perpendicular to the stacking direction. As an example, it is the circumference of a circular layering plane or the perimeter of a square layering plane.

Before the ribbon is spooled, it is machined with a two-dimensional (i.e., 2-D) shape that is parallel with the layering plane of spooling. The depth of the plane or the third dimension of a layer of the expected three-dimensional (i.e., 3-D) shape depends on the thickness of the ribbon, which is one resolution of machining dimension, and the stacking depth of the layers onto the spooler. Essentially, the final three-dimensional shape is built-up one layer or step at a time, whereby one example a step or layer is one complete rotation of the spooler. It is conceivable to see actual microscopic steps in the final shape, with the step depth based on the thickness of the ribbon. How the 3-D shape evolves in a radial or stacked direction from the layering plane of the spooler depends on how or when every next layer is machined. For instance, a channel could extend in a radial or stacked direction from the layering plane of the spooler along a straight line, a squiggly line, or a curved line. Consequently, any means to acquire the angular position of the spooler (or perimeter dimension) is required to determine or calculate the machining position of the 2-D plane of the ribbon, because as the spooled core extends in the radial direction, the perimeter dimensions of the stacked layers change at least on an angular basis. The template of the spooler assembly can be any shape, such as flat, round, square, triangular, and so-on, but the axis of rotation is in the desired plane of the template while the spooled ribbon is confined by some means in the plane of rotation.

Machining a core mass one thin layer at a time is a slower process with the following advantages. Mechanical or heat stress is reduced because machining is performed on a single thin layer of material, which mitigate collateral damage or performance degradation of the material in the final product. Heat and mechanical stress can be further reduced by localizing an active cooling process, such as forced cooling air, gas, or liquid, directly to the machining process on the thin layer of ribbon rather then the heat mass of the entire core mass. By mitigating the stress, the expensive and time consuming process of annealing may be avoided and the slower process of machining one layer at a time may in fact be more economical and faster. In any case, some core masses, such as magnetic cores of AC transformers or electric machines, require a layered or ribbon structure (i.e., laminated structure) to improve the magnetic and electrical performance of the core and the machining method described causes less collateral damage to the delicate magnetic material for reasons just describe.

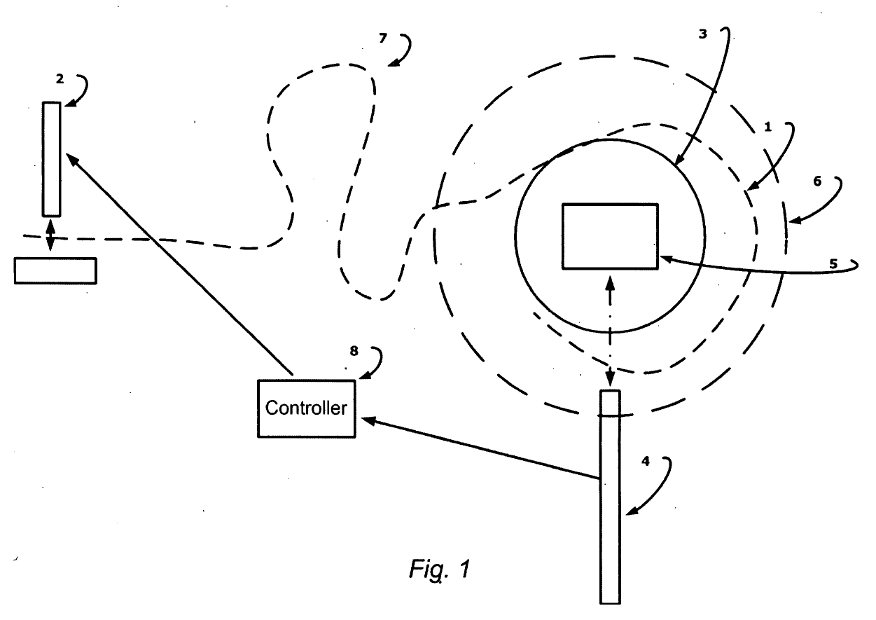

FIG. 1 shows one example of the major components of the invention. As the spooler 3 turns, the ribbon 1 wraps around the spooler 3 within the guides (or sleeves) 6 of the spooler. As the spooler turns, the perimeter detector 4 measures the distance traveled by the ribbon with the help of the perimeter focus 5. [In this case, the perimeter is actually the circumference of a circle of varying diameter as the layers of ribbon are applied. If the spooler assembly template was a square dimension, the measurement would be the perimeter of the square.] The perimeter detector can be a photo detector and the perimeter focus could be a light emitting diode (LED) or a light passing through a template of the distance of focus. Likewise, the perimeter detector could be a hall affect detector, a roller that measures distance, or a adjustable speed or angle drive that effectively measures speed, and so-on with any complementary perimeter focus. On detection, the photo-detector notifies the controller 8, which in turn commands the machine tool 2 to perform its purpose perhaps after shaping calculation, which is to modify the ribbon with a shape. How long the machine tool performs its purpose (i.e., machining) could be determined by the controller or the perimeter detector. How the tool performs is many. For instance, one machine tool can work on one edge or surface area or multiple machine tools can perform time and purpose independent or simultaneous operations on specific edges or areas of the ribbon. The ribbon may pass through an indirect path 7 of other enhancing means or components, such as dryers, adhesive applicators, idlers, brakes, a plurality of tooling, etc. Various thickness, width, material ribbon or tape could be spliced during the spooling process to change core dimensions or properties.

Other dimensions could be cut into the ribbon for winding placement, for cooling, or for structural reasons. For instance, slots in a radial direction could be machined for winding placement or for increase cooling surfaces. Channels could be cut to fill with other material for structural support, such as material with high shear or compressive strength for structural rigidity.

Other enhancing means or components may complement or enhance the machining means described. An adhesive application means may be incorporated to apply an adhesive on all or specific layers of the ribbon to bond or add structural support to the final core mass. A drier means may be incorporated to dry any cooling fluid applied to the ribbon before applying any adhesive to the ribbon or to modify the properties of the adhesive. A cleaning means may be incorporated, such as a high pressure blower. A ribbon friction, pulling, braking, or squeezing means may be applied to bring the ribbon layers closer together on the spooler. An automatic spooler (or winder) means may be incorporated to automatically spool the ribbon onto the spooler, such as comparable mechanisms found on film projectors or tape recorders. Additional machine tools that function simultaneously or sequentially may be incorporated to improve machining speed or shape complexity. An annealing means may be incorporated. A means to apply several bobbins of ribbon material could be incorporated to spool layers of ribbon with different dimensions or materials. A means to stop or to brake the ribbon during the process of machining each layer of ribbon. A means to idle the ribbon, such as with an idler arm, during machining of a layer of ribbon may be incorporated. A means to hold the raw ribbon material, such as a bobbin, may be incorporated. A means to guide the ribbon through any of the process means described.

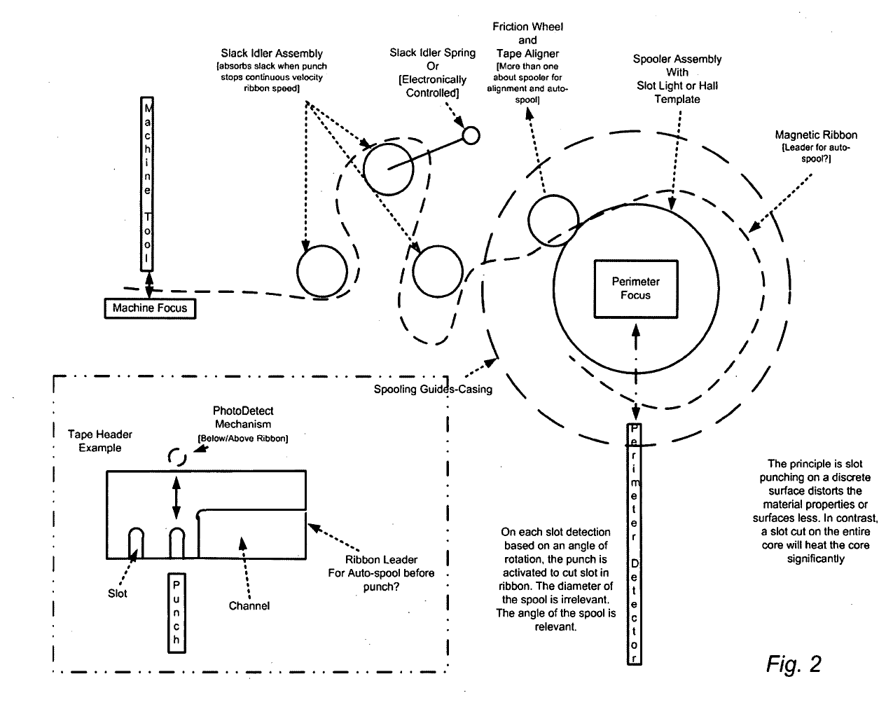

FIG. 2 shows one specific embodiment of the invention. It should be understood there are numerous embodiments of the invention with other enhancing means and components as described. For this specific embodiment, the perimeter detector and perimeter focus is an LED and photo-detector and a punch and die machine tool to shape a slot into the ribbon based on the angular position of the spooler in accordance to the slot template. This specific embodiment also includes an idler mechanism that is either spring controlled or computer (i.e., electronically-electrically) controlled. The idler mechanism adjusts the ribbon slack between the continuously moving spooler and the inherent braking of the punch and die operation. This specific embodiment also includes a friction wheel that tightens the layers of ribbon about the spooler for a denser layered finished core.

Another embodiment of this invention will incorporate a core mass of powdered metal. Powdered metal with a bonding compound (i.e., powdered metal slurry) can be molded into various shapes, such as shapes with winding slots that are ideal for a magnetic core. The method employed is to manufacture a reusable mold to the negative shape of the desired core mass. The mold will have a separable bulk chamber and a face plate, which covers the mouth of the bulk chamber. The bulk chamber and face plate attach together by any clamping means. Together, the bulk chamber and face plate show the negative shape of the desire core mass. The mold and clamping mechanism will be sufficiently strong to tolerate very high hydraulic pressures. First, a protector material, such as a piece of cellophane, plastic, etc., would be inserted into the bulk chamber to protect the mold from the bonding agent. Second, a piece composite cloth, such as a fiberglass cloth, would be inserted in the bulk chamber. Third, another piece of composite cloth would be laid over the mouth of the bulk chamber followed by another piece of protector material. Both the composite cloth and protector material are allowed to extend outside of the junction between the bulk chamber and face plate junction for wicking purposes. The face plate is attached to the bulk chamber by a clamping means, which can sufficiently hold the hydraulic pressure and allow the composite cloth to act as a wick between the bonding agent and the powdered metal. Powdered metal slurry (i.e., powdered metal and bonding agent) is pumped into the chamber between the composite cloth and the protector material under high pressure. When all cavities of the mold are filled, supplemental pressure will squeeze the excess bonding agent through the wicking junction while leaving the actual powdered metal in the mold cavity with a minimum but sufficient amount of bonding agent. The bonding agent is allowed to set before it is removed from the mold. Various bonding agents require different methods of curing. Powdered Metal core masses for electric machines or rotating transformers can be axial (pancake) or radial flux (cylindrical) design.

It is possible that additional assemblies, which are an integral component of the core mass, may be inserted into the bulk chamber before filling with powdered slurry. For instance, a pre-formed winding assembly may be inserted for rotating transformer. In this case, the winding assembly could be energized or excited to more densely pack the powdered slurry. Likewise, an axle, bearing assembly, and so-on may be inserted.

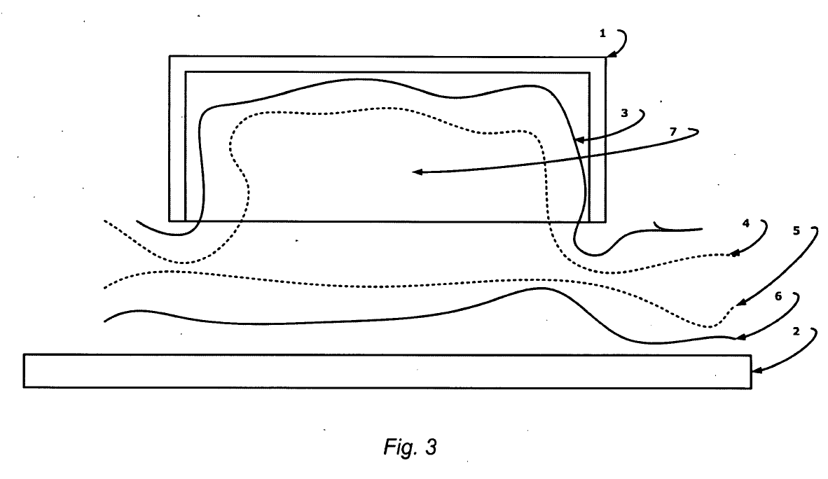

FIG. 3 shows the components of a powdered metal slurry mold. The bulk chamber 1 and face plate 2 are crude representations. All sides of the bulk chamber and face plate oriented towards the chamber cavity 7 will be designed in the negative image of the desired core shape. The protector materials 3, 6 protect the mold from the bonding agent and for easy removal of the cured core mass. The composite clothes 4, 5 form a wicking mechanism to allow excess bonding agent to squeeze out while retaining the metal powder. When the bonding agent cures, the composite cloth adds structural integrity to the core mass, as well. In some cases, the composite clothes 4 or 5 or both may be omitted in the process. The powdered metal slurry is pumped into the chamber cavity after the face plate is joined to the bulk chamber by any clamping means that is sufficient to tolerate the hydraulic pressures while simultaneously allowing wicking.

This invention provides a method to manufacture electric machine or high frequency rotating transformer cores of various air-gap area (and power rating) without resorting to customized tooling for each area or power rating. It also allows manufacturing cores with thin magnetic steel laminations or amorphous metal ribbon laminations or powdered metal, which are derivatives of nanocrystalline material. The electric machines or high frequency rotating transformers of particular focus are the Power Generator Motor (PGM) incorporating a Rotor Excitation Generator (REG) of the Electric Rotating Apparatus and Electric Machine patents of this inventor, U.S. Pat. Nos. 4,459,530, 4,634,950, 5,237,255, and 5,243,268. Like any electric machine, the form-factor of the PGM and REG can be a pancake form-factor (or axial flux). Like any electric machine or rotating transformer, the pancake form-factor incorporates slots for the placement of windings. However, this pancake form-factor with slots is now disclosed for the electric machines and related inventions incorporating Brushless Multiphase Self Commutation Control (or BMSCC).

I claim:

1. A method for manufacturing a three dimensional core mass of at least one ribbon of at least one material comprising at least the steps of:
a) Modifying said ribbon being layered onto at least one spooler;
b) Layering said modified ribbon onto said spooler with at least one layer of said ribbon;
Wherein said three dimensional core mass is built up at least one layer of said modified ribbon at a time;
Wherein said layering of said modified ribbon extends per layer in a stacked direction perpendicular to the layering plane of said spooler;
Wherein the outline of said ribbon before said modifying is distinguishable along a portion of the perimeter of said layering plane.

2. The method of claim 1 further comprising at least 2 additional steps:
Step 1: measure the perimeter of at least one said layering plane of said layering of said modified ribbon;
wherein the basis of said measurement is selected from a group consisting of angle, distance, speed, or time;
Step 2: Modify said ribbon in accordance to said measurement of said perimeter.

3. The method of claim 1 wherein the basis of said modifying is selected from a group consisting of either edge of said ribbon and either surface of said ribbon.

4. The method of claim 1 wherein said modifying is performed by at least one machining derivative further selected from a group consisting of cutting, welding, drilling, stamping, blasting, brazing, grinding, etching, chopping, punching, slicing, electrostatic discharge, acoustic, ultrasound, light, electric, annealing, and derivative tooling.

5. The method of claim 1 wherein said modifying further comprises at least one drier;
whereby said ribbon is dried.

6. The method of claim 1 wherein said modifying further comprises at least one cooler;
whereby said ribbon is cooled.

7. The method of claim 1 wherein said method for manufacturing a three dimensional core mass further comprises at least one bobbin;
whereby the raw material of said ribbon is stored.

8. The method of claim 1 wherein said method for manufacturing a three dimensional core mass of ribbon further comprises at least one method selected from a group consisting of guiding, pressing, holding, and clamping;
whereby said ribbon is confined by said method for manufacturing a three dimensional core mass of ribbon.

9. The method of claim 1 wherein said method for manufacturing a three dimensional core mass of ribbon further comprises at least one brake;
whereby the spooling is stopped to allow for modifying said ribbon.

10. The method of claim 2 wherein said measuring of said perimeter is further selected from a group consisting of electricity, light, acoustic, optical, and magnetic.

11. The method of claim 1 wherein the shape of said spooler is selected from a group further consisting of flat, cube, ball, square, round, triangular, and trapezoidal.

12. The method of claim 1 wherein said method for manufacturing a three dimensional core mass further comprises at least one applicator for applying at least one material selected from a group consisting of adhesive, liquid, air, heat, cold, and paint.

13. The method of claim 1 wherein said method for manufacturing a three dimensional core mass further comprises at least one splicer for splicing at any time various ribbon categories selected from a group consisting of material and dimension;
Wherein said various ribbon is selected from a group consisting of material, size, width, and thickness of ribbon.

14. The method of claim 1 wherein said method for manufacturing a three dimensional core mass further comprises at least one idler to mitigate the variation in ribbon movement.

15. The method of claim 1 wherein said method for manufacturing a three dimensional core mass further comprises at least one method of finishing said ribbon to mitigate anomalies after said modifying.

16. The method of claim 1 wherein said ribbon is automatically guided without intervention from the start of said method for manufacturing a three dimensional core mass.

17. The method of claim 1 wherein said method for manufacturing a three dimensional core mass further comprises at least one provider of motion further selected from a group consisting of adjustable speed drives, engines, motors, sprockets, gears, brakes, guides, idlers, belts, and pulleys.

18. The method of claim 1 wherein said method for manufacturing a three dimensional core mass further comprises at least one method of annealing;
whereby the ribbon material is annealed.

19. The method of claim 1 wherein said method for manufacturing a monitoring system selected from a group consisting of monitoring said ribbon and monitoring of said modifying;
whereby the performance of said machining derivative can be corrected.

20. A method for manufacturing a core mass of powdered metal comprising the steps of:
a) Using a re-useable mold with a face plate and a bulk chamber section:
wherein, the cavity shows the negative image of the core mass to be manufactured;
whereby, said face plate and bulk chamber sections clamp together and have sufficient strength to tolerate the expected hydraulic pressure;
b) Placing a composite of protecting materials into said cavity:
whereby said mold is protected from the bonding agent of the uncured powdered metal slurry;
c) Clamping said face plate and bulk chamber sections clamp together;
d) Pumping said powdered metal slurry into said cavity of said mold until a pressure is achieved:
whereby at least said bonding agent wicks into said protecting materials;
whereby, the least amount of said bonding agent and the most amount of said powdered metal remains;
e) Providing curing to the bonding agent;
whereby together with said bonding agent, the protecting materials forms a structural skirt.

21. The method of claim 20 comprising the insertion of at least one integral assembly before filling with powdered slurry.

22. The method as in claim 20 or claim 21 comprising art to energize the curing process further selected from a group consisting of electrical energizing, acoustical energizing, thermal energizing, ambient energizing, optical energizing, and energizing said integral assembly during the curing process.
